(19) United States
(12) Patent Application Publication
(10) Pub. No.: US 2004/0111563 A1
(43) Pub. Date: Jun. 10, 2004

(54) Method and apparatus for cache coherency between heterogeneous agents and limiting data transfers among symmetric processors

(76) Inventors: Samantha J. Edirisooriya, Tempe, AZ (US); Sujat Jamil, Chandler, AZ (US); David E. Miner, Chandler, AZ (US); R. Frank O'Bleness, Tempe, AZ (US); Steven J. Tu, Phoenix, AZ (US); Hang T. Nguyen, Tempe, AZ (US)

Correspondence Address: Dennis A. Nicholls, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/316,276

(22) Filed: Dec. 10, 2002

(51) Int. Cl. G06F 12/00

(52) U.S. Cl. 711/141

(57) ABSTRACT

A system and method for improved cache performance is disclosed. In one embodiment, cache coherency schemes are categorized by whether or not they are capable of write-back caching. A signal may convey this information among the processors, allowing them to inhibit snooping in certain cases. In another embodiment, backoff signals may be exchanged among the processors, permitting them to inhibit certain unnecessary data transfers on a system bus.

### FIELD

The present disclosure relates generally to microprocessor systems, and more specifically to microprocessor systems capable of operating in a multiprocessor environment with coherent caches.

### BACKGROUND

Processors may use caches in order to have more rapid access to data than would be possible if all data needed to be accessed directly from system memory. It is possible to read from cache much faster than reading from system memory. It is also possible to write to cache, and put off updating the corresponding data in system memory until a time convenient for the processor or its cache. When using processor caches in multiprocessor environments, care must be taken to ensure that the various copies of the data are the same, or at least that any changes be tracked and accounted for. Strict equality of the data is not necessary or even desired: as mentioned above, sometimes the cache will contain modified data and will update the system memory later. Similarly, several processors may share data. If one processor writes an updated copy of the data into its cache, it should either tell the other processors that it did so in order that they may not trust their data in the future, or it should send a copy of the updated data around to the other processors. Differing sets of rules that ensure the coherency, if not the equality, of data in multiple processors' caches are called cache coherency schemes.

One difficulty may arise in multiprocessor systems when the several processors obey rules from differing cache coherency schemes. For example, some cache coherency schemes require the immediate writing back to system memory of any memory writes to cache. Others may permit such memory writes to system memory to be delayed to enhance system performance.

Even within a multiprocessor system with processors having similar cache coherency schemes, there may be instances where unnecessary data transfers take place. They may impact overall system performance. Generally cache coherency schemes may have to compensate for worst-case scenarios. In certain circumstances this may lead to unnecessary data transfers among the processors.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a multiprocessor system, according to one embodiment.

FIG. 2 is a schematic diagram of a multiprocessor system with both ownership capable and non-ownership capable agents, according to one embodiment.

FIGS. 3A-3D are schematic diagrams of processors modifying a shared cache line, according to one embodiment of the present disclosure.

FIG. 4 is a schematic diagram of a processor with backoff signal lines, according to one embodiment of the present disclosure.

FIG. 5 is a schematic diagram of a multiprocessor system employing backoff signal lines, according to one embodiment of the present disclosure.

### DETAILED DESCRIPTION

The following description describes techniques for operating caches in a microprocessor system. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of hardware within a microprocessor system. However, the invention may be practiced in other forms of processor such as a digital signal processor, or with computers containing a processor, such as a minicomputer or a mainframe computer.

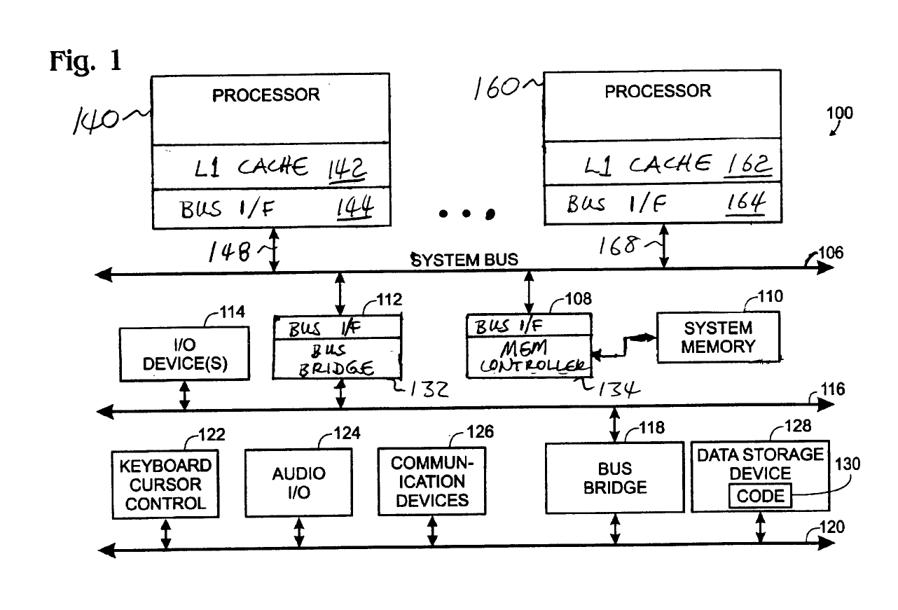

Referring now to FIG. 1, a schematic diagram of a multiprocessor system 100 is shown, according to one embodiment. The FIG. 1 system may include several processors of which only two, processors 140, 160 are shown for clarity. Processors 140, 160 may include level one caches 142, 162. In some embodiments these level one caches 142, 162 may have the same cache coherency schemes, and in other embodiments they may have differing cache coherency schemes yet still reside on a common system bus 106. Common examples of cache coherency schemes are valid/invalid (VI) caches, modified/exclusive/shared/invalid (MESI) caches, and modified/owned/exclusive/shared/invalid (MOESI) caches.

The FIG. 1 multiprocessor system 100 may have several functions connected via bus interfaces 144, 164, 112, 108 with a system bus 106. A general name for a function connected via a bus interface with a system bus is an “agent”. Examples of agents are processors 140, 160, bus bridge 132, and memory controller 134. Memory controller 134 may permit processors 140, 160 to read and write from system memory 110. Bus bridge 132 may permit data exchanges between system bus 106 and bus 116, which may be a industry standard architecture ISA bus or a peripheral component interconnect PCI bus. There may be various input/output I/O devices 114 on the bus 116, including graphics controllers, video controllers, and networking controllers. Another bus bridge 118 may be used to permit data exchanges between bus 116 and bus 120. Bus 120 may be a small computer system interface SCSI bus, an integrated drive electronics IDE bus, or a universal serial bus USB bus. Additional I/O devices may be connected with bus 120. These may include keyboard and cursor control devices 122, including mice, audio I/O 124, communications devices 126, including modems and network interfaces, and data storage devices 128, including magnetic disk drives and optical disk drives. Software code 130 may be stored on data storage device 128.

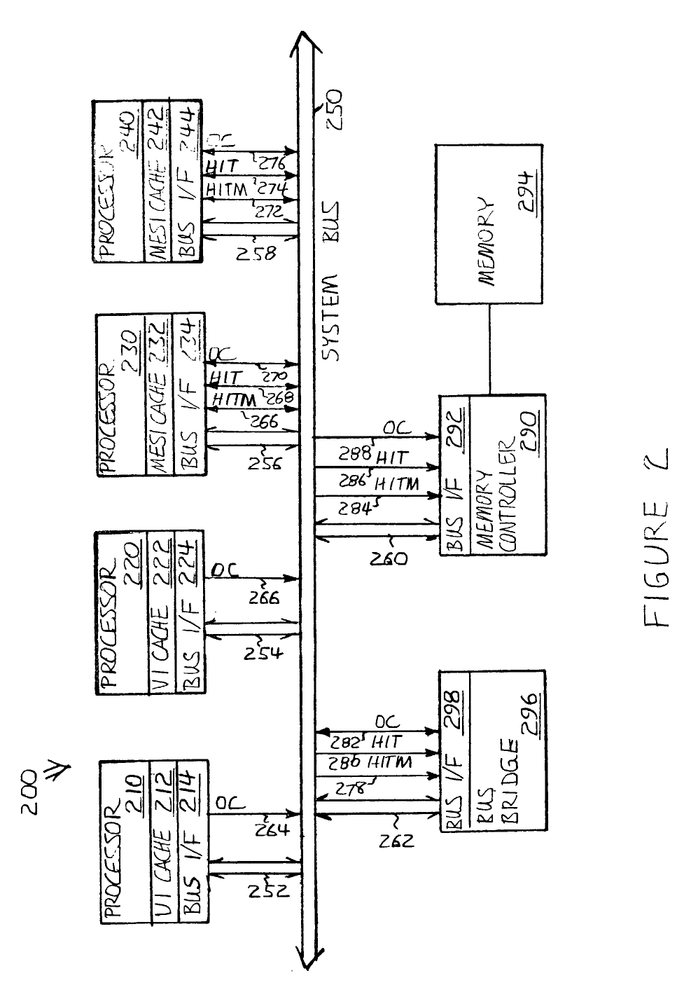

Referring now to FIG. 2, a schematic diagram of a multiprocessor system 200 with both ownership capable and non-ownership capable agents is shown, according to one embodiment. In the FIG. 2 embodiment, six agents are shown connected to system bus 250. However, in other embodiments other combinations of agents may be used when connected with a system bus.

In the present context, ownership capable agents are those including a cache that may operate in write-back mode, such as caches operating in a MESI or MOESI modes. MESI and MOESI cache operations are well-known in the art. Agents including caches with other cache protocols than MESI and MOESI may be determined to be ownership capable agents. Agents with non-write-back caches, such as write-through caches, or agents with no caches, such as bus bridges or disk controllers, may in contradistinction be called non-ownership capable agents. One example of a write-through cache is a VI cache.

Processors 210, 220 are shown including VI caches 212, 222, respectively, and bus interfaces 214, 224, respectively. The presence of the VI caches 212, 222 make processors 210, 220 non-ownership capable agents. In other embodiments, processors 210, 222 could be other kinds of non-ownership capable agents. Bus interfaces 214, 224 connect to system bus 250 via bus stubs 252, 254, respectively. Bus stubs 252, 254 may include various data, address, and control signals whose details are not significant in the present disclosure. Bus interfaces 214, 224 also include an ownership capability signal 264, 266, respectively. The ownership capability signals 264, 266 may drive a signal line on the system bus 250 to a logical false state whenever VI caches 212, 222, respectively, initiate a write-line request. The logical false state may be read by other agents on system bus 250, indicating that the processor initiating the write-line request is a non-ownership capable agent.

Processors 230, 240 are shown including MESI caches 232, 242, respectively, and bus interfaces 234, 244, respectively. The presence of the MESI caches 232, 242 make processors 230, 240 ownership capable agents. In other embodiments, processors 230, 242 could be other kinds of ownership capable agents. Bus interfaces 234, 244 connect to system bus 250 via bus stubs 256, 258, respectively. As previously mentioned, bus stubs 256, 258 may include various data, address, and control signals whose details are not significant in the present disclosure. Bus interfaces 234, 244 also include an ownership capability signal 270, 276, respectively. The ownership capability signals 270, 276 may drive a signal line on the system bus 250 to a logical true state whenever MESI caches 232, 242, respectively, initiate a write-line request. The logical true state may be read by other agents on system bus 250, indicating that the processor initiating the write-line request is an ownership capable agent.

Bus bridge 296 is shown including bus interface 298. In differing embodiments bus bridge 296 may connect system bus 250 to another bus (not shown), such an peripheral component interconnect (PCI) bus or a integrated drive electronics (IDE) bus. The fact that bus bridge 296 has no cache makes it a non-ownership capable agent. In other embodiments, bus bridge 296 could be another kind of non-ownership capable agent, such as a disk drive controller, a local area network controller, or a graphics controller. Bus interface 298 connects to system bus 250 via bus stub 262. Bus interface 298 may also include an ownership capability signal 282. The ownership capability signal 282 may drive a signal line on the system bus 250 to a logical false state whenever bus bridge 296 initiates a write request to memory 294. The logical false state may be read by other agents on system bus 250, indicating that the agent initiating the write request is a non-ownership capable agent.

Memory controller 290 is shown connecting memory 294 to the system bus 250 via a bus interface 292. The bus interface 292 may connect with a bus stub 260 and additionally receive an ownership capability signal 288.

Some of the agents may generate signals showing the results of their snoops, if the agents are capable of snooping. For example, processor 230 may generate a HIT signal 268 and a HITM signal 266 as the result of its snooping. These signals may be set to a true logic state if a hit to an exclusive E or shared S state (HIT) or a hit to a modified M state (HITM) is determined. Neither may be set true if a snoop miss is determined. The request agent, for example processor 240, may in turn examine the input on its own HIT signal 274 and HITM signal 272 to determine the other agents' response to its read or write request. In some embodiments, the agent driving the HIT signal and HITM signal may drive both true, which may be used to signal a need to insert a stall time period in a response.

Ownership capable agents such as processor 230 and processor 240 generally only generate a write line request in one of two case. One case is when a dirty cache line is evicted due to the cache requiring to use that particular cache line's location for a new entry, a situation sometimes referred to as “victimizing” the old cache line. Here “dirty” cache lines may include those cache lines that are in the modified M or owned O states in MESI or MOESI protocol caches. The other case is when a dirty cache line is caught in a snoop initiated by another agent's read line request. In either case, ownership capable agents are writing to memory a cache line that should not be in any other agent's cache: none of the other agents with caches should have that particular cache line in a valid state in their local caches.

In order to reduce snooping in cases where it is not mandatory, in one embodiment each agent reads the ownership capability signal generated by the agent requesting a write-line request. If the requesting agent of a write-line request drives the ownership capability signal true, then other agents with caches need not snoop their caches. Conversely, if the requesting agent of a write-line request drives the ownership capability signal false, then the other agents with caches do need to snoop their caches.

In one example, processor 230 may request a write-line request. Because processor 230 is ownership capable, it drives its ownership capable signal 270 true. Another agent, such as processor 240 with MESI cache 242, then may read this true value on its incoming ownership capable signal 276 and realize that processor 240 need not snoop its MESI cache 242. In the FIG. 2 embodiment, processors 210, 220 need to drive but not necessarily receive an ownership capability signal 264, 266. In one embodiment, VI caches 212, 222 are not capable of snooping at all. In other embodiments, processors 210, 220 may have non-ownership capable caches that are capable of snooping, and in this example may respond to a true value on their ownership capable signals 264, 266 by electing not to snoop.

In a second example, processor 210 may request a write-line request. Because processor 210 is non-ownership capable, it drives its ownership capable signal 264 false. Other agents, such as processors 230, 240 with MESI caches 232, 242, then may read this false value on their incoming ownership capable signals 270, 276 and realize that processors 230, 240 should snoop their respective MESI caches 232, 242. In the FIG. 2 embodiment, processor 220 needs to drive but not necessarily receive an ownership capability signal 266. In one embodiment, VI cache 222 is not capable of snooping at all. In other embodiments, processor 220 may have a non-ownership capable cache that is capable of snooping, and in this example may respond to a false value on its ownership capable signal 266 by electing to snoop.

In a third example, bus bridge 296 may request a write-line request. Because bus bridge 296 is non-ownership capable, it drives its ownership capable signal 282 false. Other agents, such as processors 230, 240 with MESI caches 232, 242, then may read this false value on their incoming ownership capable signals 270, 276 and realize that processors 230, 240 should snoop their respective MESI caches 232, 242. In the FIG. 2 embodiment, processors 210, 220 need to drive but not necessarily receive an ownership capability signal 264, 266. In one embodiment, VI caches 212, 222 are not capable of snooping at all. In other embodiments, processors 210, 220 may have non-ownership capable caches that are capable of snooping, and in this example may respond to a false value on their ownership capable signals 264, 266 by electing to snoop.

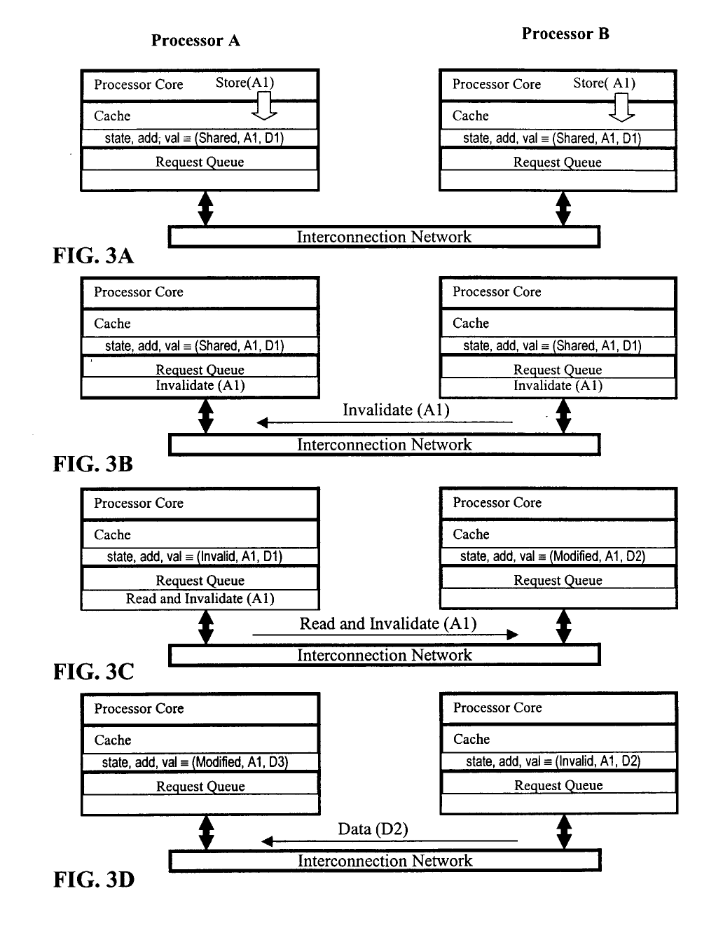

Referring now to FIGS. 3A-3D, schematic diagrams of processors modifying a shared cache line are shown, according to one embodiment of the present disclosure. In the FIGS. 3A-3D embodiment, Processor A and Processor B may have one of the cache coherency protocols that include a shared state, such as an S state, such as modified shared invalid (MSI), MESI, or MOESI. The “owned” or O state may be less well-known than the M, E, S, or I states. The O state may be considered a modified-shared state, which allows shared data that is modified to remain in the cache. The cache that contains an O cache line takes on the responsibility to update the memory at a later time. For the purpose of the remainder of the present disclosure, the “owned” or O state in MOESI may be considered a special case of a shared state.

In FIG. 3A, both Processor A and Processor B initiate a store instruction of data D3, D2, respectively, to address A1. At this stage both Processor A and Processor B include a cache line including address A1 with data D1. Also at this state both Processor A and Processor B have no entries in their respective request queues.

In FIG. 3B, both Processor A and Processor B have snooped their own caches in response to the two store instructions. Both Processor A and Processor B find a cache line in their respective caches with address A1, data D1, and in the S state. Both Processor A and Processor B then promote the store instruction to an “invalidate at address A1” in the request queues of the respective processors. The processor that is ready first will execute from its request queue first. IN the FIG. 3B example, Processor B is ready first and sends the “invalidate at address A1” message to Processor A.

In FIG. 3C, Processor B has written data D2 into the cache line containing address A1, and changed the state to M. Processor A has processed the “invalidate at address A1” message received from Processor B, and therefore now has the cache line including address A1 in an invalid state. This changes the results of the previous snooping, and therefore the “invalidate at address A1” in the request queue of Processor A is upgraded to a “read and invalidate line at address A1”. When Processor A executes this from its request queue, it sends a “read and invalidate line at address A1” message to Processor B.

In FIG. 3D, Processor A has written data D3 into the cache line containing address A1, and changed the state to M. Processor B has processed the “read and invalidate line at address A1” message received from Processor A, and therefore now has the cache line including address A2 in an invalid state. As part of this responding to the “read and invalidate line at address A1” message received from Processor A, Processor B updates the contents at address A1 in main memory (not shown) and also sends a copy of the data D2 to Processor A. This copy of the data D2 is not needed by Processor A.

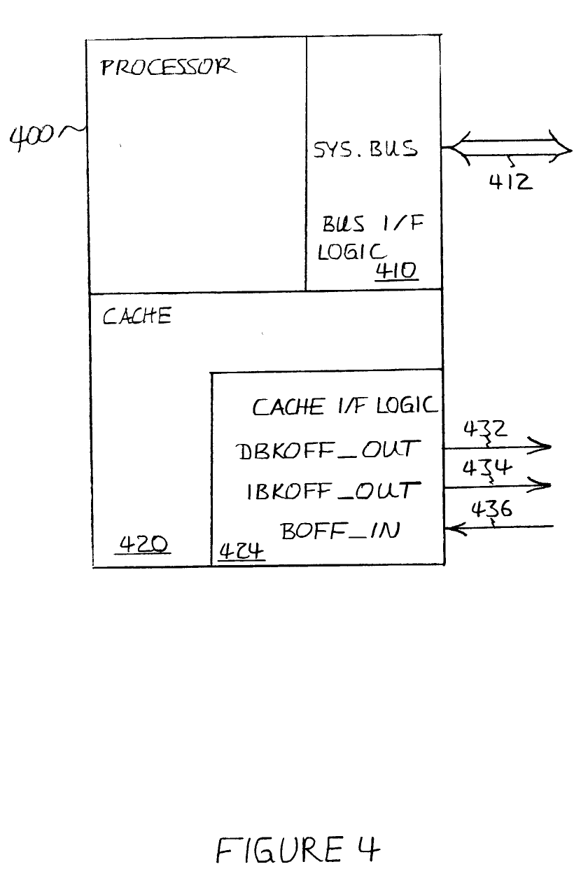

Referring now to FIG. 4, a schematic diagram of a processor 400 with backoff signal lines is shown, according to one embodiment of the present disclosure. Processor 400 includes a bus interface logic 410 that connects to a system bus via a system bus stub 412. Processor 400 also includes a cache 420 including a cache logic 424 that among other functions may control a set of backoff signal lines.

In order to reduce the intra-processor transfer of data in cases where it is not necessary, processor 400 includes two backoff output signals, data backoff DBKOFF_OUT 432 and intervention backoff IBKOFF_OUT 434, and a backoff input signal BOFF_IN 436. These three backoff signals may be used to determine when a processor or other agent may be able to back-off from sending data in response to a “read and invalidate line” command in certain circumstances. In the FIG. 4 embodiment, the three backoff signals DBKOFF_OUT 432, IBKOFF_OUT 434, and BOFF_IN 436 are implemented as individual signals capable of assuming logic levels corresponding to logic states of true or false. In other embodiments, the three backoff signals may be implemented as messages on a common signal line, or as messages over existing bus signal lines such as shown as bus stub 412. Also, in the FIG. 4 embodiment, the three backoff signals DBKOFF_OUT 432, IBKOFF_OUT 434, and BOFF_IN 436 are shown as connecting with and being generated by (or received by) a cache interface logic 424 within cache 420. In other embodiments, the three backoff signals DBKOFF_OUT 432, IBKOFF_OUT 434, and BOFF_IN 436 may be generated by (or received by) other circuits within processor 400 such as bus interface logic 410 or cache 420.

DBKOFF_OUT 432 may be set true by processor 400 (or in other cases, another snooping agent) during a snoop phase responding to processor's 400 own memory transfer request (self-snoop), and may be used to inhibit other processors or agents from providing data. Specifically, DBKOFF_OUT 432 may be set true during a snoop phase in response to a read and invalidate line request initiated by processor 400 in those circumstances when processor 400 has the specified cache line in cache 420 in a shared state, which may include an S state or an O state. Processor 400 may not set DBKOFF_OUT 432 true when snooping in response to memory transfer requests initiated by agents other than processor 400. Generally processor 400 may set DBKOFF_OUT 432 true during the same time period when processor 400 may set IBKOFF_OUT 434 true, where IBKOFF_OUT 434 operates as set forth in the following paragraph.

IBKOFF_OUT 434 may be set true by processor 400 during a snoop phase responding to processor's 400 own memory transfer request (self-snoop), or during a snoop phase responding to a memory transfer request initiated by another processor or agent. IBKOFF_OUT 434 may be used to inhibit other processors or agents from providing data in response to their snoops. In one embodiment, IBKOFF_OUT 434 being set true may indicate both that the requested cache line is in a valid state, and that processor 400 is capable of intervening and supplying the data of that cache line directly to the requesting agent. In one embodiment, a valid state may be considered one of the group consisting of an M state, an O state, an S state, or an E state.

BOFF_IN 436 may be used by processor 400 to receive backoff signals generated by other processors or agents. These backoff signals may be presented either individually or combined to BOFF_IN 436. In one embodiment, processor 400 may be prevented from supplying data for a requested cache line when BOFF_IN 436 is true. In one specific embodiment, if processor 400 has the requested cache line in cache 420 in a shared state, to include either an S state or an O state, then processor 400 may intervene to supply the date from the requested cache line if and only if BOFF_IN 436 is true.

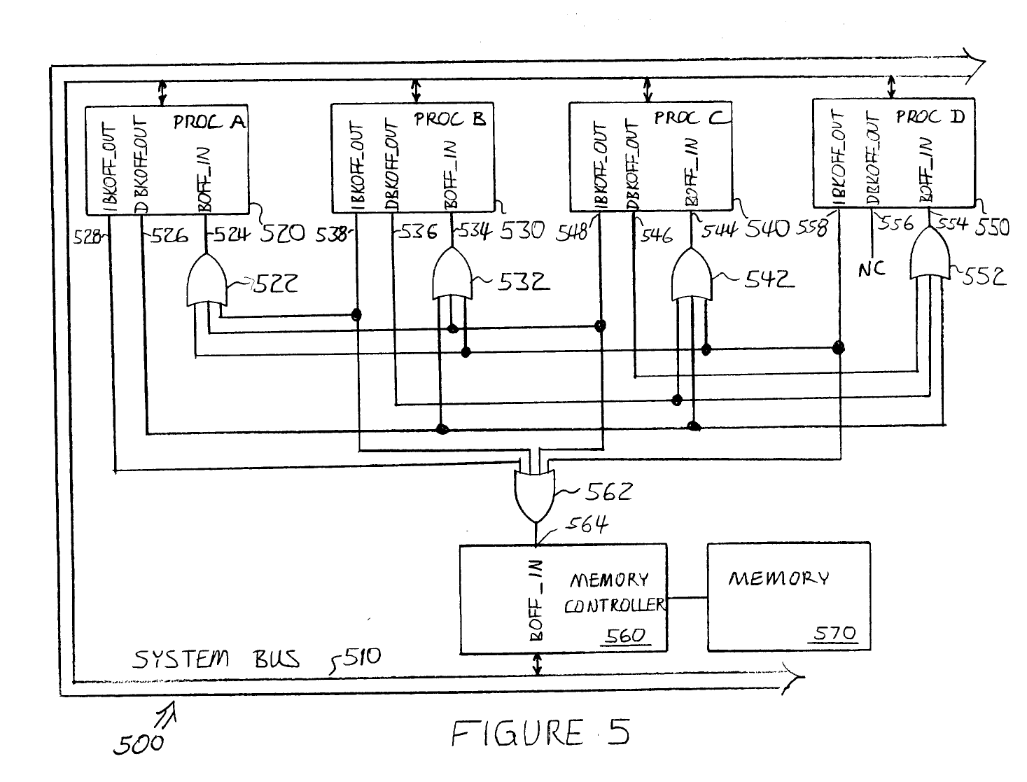

Referring now to FIG. 5, a schematic diagram of a multiprocessor system employing backoff signal lines is shown, according to one embodiment of the present disclosure. The FIG. 5 embodiment presumes the backoff signals utilize positive logic signals, where a low voltage is interpreted as a logical “false” and a higher voltage is interpreted as a logical “true”. In other embodiments, negative logic signals or a mixture of some positive and some negative logic signals could be used. In these embodiments, the logic gate changes required would be well-known in the art.

Processor A 520, processor B 530, processor C 540, and processor D 550 are connected with one another by a system bus 510. They are also connected to memory 570 via a memory controller 560 attached to the system bus 510. Each processor may include three backoff signals DBKOFF_OUT, IBKOFF_OUT, and BOFF_IN. In one embodiment, these signals may function as the DBKOFF_OUT, IBKOFF_OUT, and BOFF_IN signals of FIG. 4. BOFF_IN 564 of memory controller 560 may function in a simpler manner than the BOFF_IN signal of FIG. 4, and may inhibit memory controller 560 from supplying the data from the requested cache line in memory 570 whenever BOFF_IN 564 is held true.

If any of the processors, processor A 520, processor B 530, processor C 540, or processor D 550, include a requested cache line in a valid state, then at least one of the IBKOFF_OUT signals, IBKOFF_OUT 528, IBKOFF_OUT 538, IBKOFF_OUT 548, or IBKOFF_OUT 558, will be true. Hence the output of gate 562, connected to BOFF_IN 564, will be true and thereby inhibit memory controller 560 from responding with data from memory 570 for the requested cache line. This inhibited response may have been unnecessary or duplicative. And any data received from memory 570 may require more time than when receiving data from the cache of another agent.

It is possible to consider the processors, processor A 520, processor B 530, processor C 540, and processor D 550, as being in a logical order with respect to one another. It may further the discussion to consider them as either being to the left or the right of one another: however, what may be significant is the logical ordering, not the physical ordering, of the processors. Each processor, processor A 520, processor B 530, processor C 540, and processor D 550, has an output of a gate, gate 522, gate 532, gate 542, and gate 562, respectively, connected to its BOFF_IN signals, BOFF_IN 524, BOFF_IN 534, BOFF_IN 544, and BOFF_IN 564, respectively. In one embodiment, the inputs of each gate, gate 522, gate 532, gate 542, and gate 562, are connected to the IBKOFF_OUT signals from processors to their right and to the DBKOFF_OUT signals from processors to their left. This connection of backoff signals may be used to inhibit data responses from agents that have a cache line in a shared state, either an S state or an O state, with an agent that initiates a read and invalidate line transaction. It may also provide a deterministic manner of permitting one and only one agent that has a cache line in a shared state from supplying data to the requesting agent if the requesting agent does not have the data in the cache line in a valid state.

A series of rules may accompany the circuits shown in FIG. 5 or similar embodiments. In one embodiment, after generating a read and invalidate line request, if the requesting agent has the specified cache line in a shared S state or O state, then it may inform the other agents, including the memory controller 560, that it does not want the data in their caches, if present, by setting its DBKOFF_OUT true and IBKOFF_OUT true during the snoop response phase time period. The requesting agent may then update its own cache line and mark it as modified M state.

If the requesting agent has the specified cache line in an invalid I state, and another snooping agent (e.g. a processor) after its snoop is able to intervene and provide the data for the specified cache line, then the requesting agent may wait for the other agent to provide the data for the specified cache line. Then the requesting agent may update the data in the cache line and mark it as modified M state.

Finally, if the requesting agent has the specified cache line in an invalid I state, and no other snooping agent after its snoop is able to intervene and provide the data for the specified cache line, then the requesting agent may wait for memory controller to provide the data for the specified cache line. Then the requesting agent may update the data in the cache line and mark it as modified M state.

The responsibilities of snooping agents, such as processors, may be as follows. Upon receiving a read and invalidate line request, if the snooping agent has the data for the specified cache line in a shared S state or O state, then it may set its IBKOFF_OUT true, indicating it is capable of intervening. If the snooping agent has a false input to its own BOFF_IN, then it may provide the data to the requesting agent. On the other hand, if the snooping agent has a true input to its own BOFF_IN, then it may not provide the data to the requesting agent. In either case the snooping agent may then mark its specified cache line as invalid I state.

If the snooping agent has the data for the specified cache line in either a modified M state or exclusive E state, then it may set its IBKOFF_OUT true, indicating it is capable of intervening. Since the snooping agent need not respond to signals on its own BOFF_IN when it has data for the specified cache line but not in a shared state, it may unconditionally provide the data to the requesting agent. The snooping agent may then mark its specified cache line as invalid I state.

Consider the following first example of how the FIG. 5 connection of backoff signals may be used to inhibit data responses from agents that have a cache line in a shared state with an agent that initiates a read and invalidate line transaction. In this first example, let processor C 540 initiate a read and invalidate line transaction for a specified cache line. Furthermore, let all four processors, processor A 520, processor B 530, processor C 540, and processor D 550, have the data in the specified cache line in a shared state. In this case, processor C 540 already has the data required in the cache line so any data transfers from processor A 520, processor B 530, and processor D 550 would be unnecessary. Because processor C 540 has the data required in a shared state in the specified cache line, and because processor C 540 was the initiator of the read and invalidate line request, processor C 540 sets its DBKOFF_OUT 546 true. Because processor C 540 has found a valid copy of the data of the specified cache line in its own cache, processor C 540 sets its IBKOFF_OUT 548 true. DBKOFF_OUT 546 being true goes through gate 552 and inhibits processor D 550 from responding with data. All that processor D 550 does is change the cache line status to invalid I state. IBKOFF_OUT 548 being true goes through gates 532, 522 and inhibits processor A 520 and processor B 530 from responding with data. All that processor A 520 and processor B 530 do is change the respective cache line statuses to invalid I states. Subsequent to the invalidation in the other processors, processor C 540 has the data in an exclusive E state, and then may write to the cache line, causing it to progress to the modified M state. Note that since at least one IBKOFF_OUT line is true, memory controller 560 is inhibited from sending data from memory 570 for the specified cache line to processor C 540.

Consider the following second example of how the FIG. 5 embodiment may provide a deterministic manner of permitting one and only one agent that has a cache line in a shared state from supplying data to the requesting agent if the requesting agent does not have the data in the cache line in a valid state. In this second example, let processor B 530 initiate a read and invalidate line transaction for a specified cache line. Furthermore, let processor A 520, processor C 540, and processor D 550, have the data in the specified cache line in a shared state. In this case, processor B 530 does not have the data required in the cache line (or may have it in an invalid I state), and needs at least one copy of the data. Because processor B 530 does not have the data required in the specified cache line, processor B 530 retains its DBKOFF_OUT 536 as false. Because processor B 530 has not found a valid copy of the data of the specified cache line in its own cache, processor B 530 retains its IBKOFF_OUT 538 as false. Now the other processors, processor A 520, processor C 540, and processor D 550, did not initiate the read and invalidate line transaction, so none of them may set their DBKOFF_OUT true. However, all have the data in the specified cache line in a shared state, and therefore all may set their IBKOFF_OUT true. When IBKOFF_OUT 528, IBKOFF_OUT 548, and IBKOFF_OUT 558 are all true, processor A 520 and processor C 540 are inhibited from sending their copy of the data in the specified cache line to processor B 530. Only processor D 550 may send its copy of the data in the specified cache line to processor B 530. Then processor A 520, processor C 540, and processor D 550 invalidate their data in the respective specified cache lines. Note that since at least one IBKOFF_OUT line is true, memory controller 560 is inhibited from sending data from memory 570 for the specified cache line to processor B 530.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An agent, comprising:
a cache memory; and
a bus interface coupled to said cache memory and to a bus, including an ownership capable interface to said bus, wherein said ownership capable interface is to communicate a ownership capability status when said cache initiates a write-line transfer.

2. The agent of claim 1, wherein said bus interface is to signal false via said ownership capable interface when said cache is write-through.

3. The agent of claim 1, wherein said bus interface is to signal true via said ownership capable interface when said cache is write-back.

4. The agent of claim 3, wherein said bus interface is to receive a remote ownership capability status from a remote agent.

5. The agent of claim 4, wherein said cache is to snoop said cache responsive to said remote ownership capability status when said remote ownership capability status is false.

6. The agent of claim 5, wherein said cache is to not snoop said cache responsive to said remote ownership capability status when said remote ownership capability status is true.

7. The agent of claim 1, wherein said ownership capable interface is a signal pin.

8. A method, comprising:
initiating a write-line transaction from a first agent;
communicating an ownership capability status of said first agent over a bus;
determining whether a second agent should perform a cache snoop responsive to said ownership capability status.

9. The method of claim 8, wherein said communicating includes setting a logic state at a device pin.

10. The method of claim 8, wherein said determining includes determining that said second agent should not perform a cache snoop when said ownership capability status is true.

11. The method of claim 8, wherein said determining includes determining that said second agent should perform a cache snoop when said ownership capability status is false.

12. A system, comprising:
a first agent including a first cache and a first bus interface to a bus, wherein said first bus interface to drive an ownership capable status signal false when said first cache initiates a first write-line request;
a second agent including a second cache and a second bus interface to said bus, wherein said second bus interface to drive said ownership capable status signal true when said second cache initiates a second write-line request; and
a third agent with a third bus interface to said bus, wherein said third bus interface to drive said ownership capable status signal false when said third agent initiates a third write-line request.

13. The system of claim 12, wherein said second cache to snoop responsive to said ownership capable status signal subsequent to said first write-line request.

14. The system of claim 12, wherein said second cache to snoop responsive to said ownership capable status signal subsequent to said third write-line request.

15. The system of claim 12, wherein said first cache to snoop responsive to said ownership capable status signal subsequent to said third write-line request.

16. The system of claim 12, wherein said first cache to not snoop responsive to said ownership capable status signal subsequent to said second write-line request.

17. An agent, comprising:
a cache memory including a cache logic;
a first backoff output signal coupled to said cache logic to indicate that said agent does not need a second agent to supply data for a first cache line; and
a backoff input signal coupled to said cache logic to permit said cache memory to intervene with data for a second cache line if said backoff input signal is false.

18. The agent of claim 17, wherein said first backoff output signal is true when said first cache line is present in said cache memory in a shared state.

19. The agent of claim 17, wherein said first backoff output signal is false when said first cache line is present in said cache memory in an invalid state.

20. The agent of claim 17, wherein said cache transmits said data for said second cache line when said second cache line is within said cache in a shared state, and when said backoff input signal is false.

21. The agent of claim 17, further comprising a second backoff output signal to indicate when said cache memory includes said second cache line in a valid state.

22. The agent of claim 21, wherein said second backoff output signal is true when said cache is capable of intervening.

23. A method, comprising:
initiating a cache line write request for a first cache line in a first agent;
performing a snoop to a first cache of said first agent;
initiating a read and invalidate request in said first agent; and
setting a first backoff output signal true if said first cache line is in a shared state.

24. The method of claim 23, further comprising setting a first backoff signal false if said first cache line is not in a shared state.

25. The method of claim 23, further comprising receiving said read and invalidate request in a second agent.

26. The method of claim 25, further comprising snooping a second cache of said second agent responsive to said read and invalidate request, and determining a state of a backoff input signal of said second agent.

27. The method of claim 26, further comprising setting a second backoff output signal of said second agent true if said first cache line is in a valid state in said second cache.

28. The method of claim 27, further comprising providing said first cache line in said second cache to said first cache when said first cache line in said second cache is in a shared state, and when said state of said backoff input signal is false.

29. A system, comprising:
a bus;
a first agent coupled to said bus, including a first cache, a first backoff output signal coupled to said first cache to indicate that said first cache does not need externally supplied data for a first cache line, and a first backoff input signal coupled to said cache to permit said cache to intervene with data for a second cache line if said backoff input signal is false;
a memory controller coupled to said bus, including a second backoff input signal to permit said memory controller to intervene with data for a second cache line if said backoff input signal is false; and
an audio input/output controller coupled via a bus bridge to said bus.

30. The system of claim 29, wherein a second backoff output signal of said first agent is coupled to said second backoff input signal of said memory controller.

31. The system of claim 30, further comprising a second agent coupled to said bus, including a third backoff output signal to indicate when a second cache includes said second cache line in a valid state, and a third backoff input signal coupled to said second cache to permit said second cache to intervene with data for said first cache line if said third backoff input signal is false.

32. The system of claim 31, wherein said third backoff output signal is coupled to said first backoff input signal and said second backoff input signal.

33. The system of claim 31, wherein said first backoff output signal is coupled to said third backoff input signal.
